(19) United States
(12) Patent Application Publication
(10) Pub. No.: US 2021/0143693 A1
(43) Pub. Date: May 13, 2021

(54) ELECTRIC MACHINE WITH IN-SLOT STATOR COOLING

(71) Applicant: GM GLOBAL TECHNOLOGY OPERATIONS LLC, Detroit, MI (US)

(72) Inventors: Thomas W. Nehl, Shelby Township, MI (US); Farzad Samie, Franklin, MI (US); Alireza Fatemi, Canton, MI (US); Derek F. Lahr, Howell, MI (US); Tito R. Huffman, East Pointe, MI (US)

(73) Assignee: GM GLOBAL TECHNOLOGY OPERATIONS LLC, Detroit, MI (US)

(21) Appl. No.: 16/678,486

(22) Filed: Nov. 8, 2019

(51) Int. Cl. H02K 3/24; H02K 1/16; H02K 1/27; H02K 7/00; H02K 11/33; H02K 21/14; B60L 53/22; B60K 11/02

(52) U.S. Cl. CPC H02K 3/24; H02K 1/16; H02K 1/276; H02K 7/006; B60L 2210/10; H02K 21/14; B60L 53/22; B60K 11/02; H02K 11/33

(57) ABSTRACT

A rotary electric machine includes a rotor assembly, stator, stator windings, and a coolant manifold. The rotor assembly includes a rotor and a rotor shaft. The stator is spaced apart from the rotor by a stator-rotor airgap and has stator teeth defining enclosed stator slots. Distal ends of adjacent stator teeth are joined together or integrally formed such that the enclosed stator slots are not contiguous with the airgap. The stator windings constructed from hairpin or bar-type conductors extend axially through the stator within the enclosed stator slots. The coolant manifold is in fluid communication with a coolant supply and configured to seal against an axial end surface of the stator to enclose a portion of the stator windings. The manifold receives and directs coolant from the coolant supply into the enclosed stator slots through the axial end surface to cool the stator via forced convection.

### INTRODUCTION

Electric traction motors and motor generator units, which are commonly referred to in the art as rotary electric machines, are used to perform work in a wide variety of electromechanical systems. Such machines include a rotating member, i.e., a rotor, that is spaced a short distance apart from a stationary member or stator. In a typical stator construction, multiple stator teeth are attached at one end to a cylindrical stator core to project radially toward the rotor. Adjacent stator teeth are separated from each other by a respective stator slot, with distal ends of the adjacent stator teeth spaced apart from each other by a tooth gap. Each stator slot is filled with conductive wires or solid bar segments to form a set of stator windings. In a polyphase rotary electric machine, an alternating current (“AC”) input voltage is applied to the stator windings to energize the stator. Interaction between the respective magnetic fields of the rotor and stator ultimately generates forces in the rotor-stator airgap. Rotation of the rotor results, with such rotation thereafter directed to a load.

A rotary electric machine may generate substantial amounts of heat. This is particularly true when the electric machine operates at high speeds and output torque levels. While the above-noted stator windings are well-insulated to ensure electrical isolation of the individual phase windings, heat is nevertheless generated during sustained high-power operations. Heat resulting from copper and iron losses within the stator can eventually degrade the insulation. As a result, thermal management systems are used in the construction of the stator to regulate the stator temperature. For instance, the stator's end windings, which may be exposed at distal ends of the stator, are often sprayed with coolant, or the stator housing may be wrapped in a cooling jacket.

### SUMMARY

The present disclosure relates to the enhanced convection-based cooling of a stator within a rotary electric machine. In particular, each of the above-described stator slots is fully enclosed at both of its radial ends to construct an in-slot coolant passage. An application-suitable coolant, such as but not limited to automatic transmission fluid, is circulated to a coolant manifold disposed at axial ends of the stator. The coolant manifold directs the coolant axially into the in-slot coolant passages, with the admitted coolant thereafter flowing axially through the stator. By enclosing the stator slots in this manner, a uniform/360° flow of coolant is established around the bar conductors forming the stator windings. Electromagnetic efficiency of the electric machine is thereby optimized with minimal degradation of torque performance by removing heat from the stator directly from its source, i.e., the energized stator windings.

In an exemplary embodiment, the rotary electric machine includes a rotor assembly, a stator, stator windings, and the above-noted coolant manifold. The rotor assembly includes a rotor and a rotor shaft that are connected together and configured to rotate about an axis of rotation. The stator, which is spaced apart from the rotor by a stator-rotor airgap, has a set of stator teeth collectively defining stator slots. Distal radial ends of adjacent pairs of the stator teeth are joined together or integrally formed such that the stator slots are fully enclosed, i.e., not contiguous with the airgap. The stator windings as contemplated herein are constructed from bar-type or “hairpin” conductors that extend axially through the stator within the stator slots.

The coolant manifold in this particular embodiment is in fluid communication with a coolant supply, constructed of non-magnetic material, and configured to seal against an axial end surface of the stator. Sealing in this manner encloses a portion of the stator windings, i.e., exposed turns of the stator windings, as will be appreciated by those of ordinary skill in the art. The coolant manifold receives coolant from the coolant supply, directs the received coolant into the closed stator slots through the axial end surface of the stator, and thereby cools the stator via forced convection.

A cross-sectional shape of the stator windings may be a non-rectangular polygon in some embodiments and a rectangular shape in others.

An outer perimeter surface of at least one of the stator windings may optionally define a concave channel configured to conduct more of the coolant along the outer perimeter surface.

The coolant manifold may include opposing axial walls joined by a radial wall, such that a manifold channel is defined by the coolant manifold and the axial end surface of the stator. The axial walls abut and seal against the end surface of the stator to thereby encapsulate the stator windings within the manifold channel. One of the axial walls may include a ramped surface, with the stator windings being skewed in a radially outward direction via the ramped surface.

A biasing member may be used to apply a continuous compressive force to the coolant manifold. For instance, the biasing member may be a fastener, beam, or other structure configured to react against a stationary member to thereby apply the continuous compressive force.

Spacing between adjacent stator windings within each of the enclosed stator slots may be unevenly distributed such that more coolant is directed to the stator windings located in proximity to an outer diameter surface of the stator relative to distribution to the stator windings located in proximity to an inner diameter surface of the stator.

The rotor shaft in some applications may be connected to a driven load, e.g., aboard a motor vehicle having a coolant pump. The coolant is circulated via the coolant pump in such an embodiment.

An electric propulsion system is also disclosed herein. An embodiment of the electric propulsion system includes a supply of coolant, a high-voltage battery pack, a direct current-to-direct current (“DC-DC”) converter connected to the high-voltage battery pack, a traction power inverter module (“TPIM”) connected to the DC-DC converter and configured to output an alternating current (“AC”) voltage, and the above-noted rotary electric machine. The electric machine in this embodiment is a polyphase rotary electric machine connected to the TPIM and energized via the AC voltage.

A method is also disclosed for cooling a stator of a rotary electric machine. The method may include providing the above-noted stator, which is spaced apart from the rotor by a stator-rotor airgap and has stator teeth collectively defining stator slots. Distal radial ends of adjacent pairs of the stator teeth are joined together or integrally formed such that the stator slots are not contiguous with the airgaps. Stator windings are constructed from hairpin or bar-type conductors and extend axially through the stator within the stator slots.

The method includes sealing an annular coolant manifold against an axial end surface of the stator to thereby enclose therein a portion of the stator windings. The method also includes circulating coolant from a coolant supply into the enclosed stator slots through the axial end surface of the stator via the annular coolant manifold to thereby cool the stator via forced convection.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic illustration of an exemplary mobile platform having a rotary electric machine whose stator is cooled via in-slot forced convection as set forth herein.

FIG. 2 is a schematic cross-sectional illustration of a portion of the electric machine shown in FIG. 1 depicting enclosed stator slots functioning as in-slot coolant passages.

FIGS. 3A and 3B are schematic cross-sectional illustrations of bar-style conductors that may be used in the stator shown in FIG. 2.

FIG. 4 is a cross-sectional illustration of the electric machine shown in FIG. 1 inclusive of a coolant manifold for in-slot stator cooling.

The present disclosure is susceptible to modifications and alternative forms, with representative embodiments shown by way of example in the drawings and described in detail below. Inventive aspects of this disclosure are not limited to the disclosed embodiments. Rather, the present disclosure is intended to cover modifications, equivalents, combinations, and alternatives falling within the scope of the disclosure as defined by the appended claims.

### DETAILED DESCRIPTION

Referring to the drawings, wherein like reference numbers refer to the same or like components in the several Figures, an electric propulsion system 10 is depicted schematically in FIG. 1. The electric propulsion system 10 includes a rotary electric machine 12 having a rotor assembly (“R”) 14 and a stator (“S”) 16. The stator 16 produces heat during sustained high-power/high-torque operating modes of the electric machine 12. The present teachings are therefore intended to enable efficient real-time forced convection-based cooling of the stator 16 using a coolant manifold 60A as set forth herein.

An application-suitable coolant 21, e.g., automatic transmission fluid (“ATF”) or a diluted ethylene glycol mixture, may be stored in a sump 22 and circulated using a coolant pump (“P”) 20, with the resulting flow of coolant 21 indicated by arrow F. The coolant 21 is conducted into the coolant manifold 60A, which in turn seals against the stator 16. The coolant manifold 60A directs the coolant 21 into the stator 16, upon which the coolant 21 flows axially through the stator 16 via an enclosed slot structure as described in detail below with reference to FIGS. 2-4, ultimately exiting via an additional coolant manifold 60B (see FIG. 4) in some embodiments.

Within the exemplary electric propulsion system 10 depicted in FIG. 1, the rotor assembly 14 is positioned adjacent to the stator 16 and separated therefrom by an airgap G (see FIG. 2). In some configurations of the electric machine 12, the rotor assembly 14 may be arranged concentrically within the stator 16, i.e., the stator 16 may circumscribe and surround the rotor assembly 14. The electric machine 12 would thus embody a radial flux-type machine, and the above-noted airgap G would be a radial stator-rotor airgap. Other configurations of the electric machine 12 may be realized in which the relative positions of the rotor assembly 14 and the stator 16 are reversed, with the rotor assembly 14 circumscribing and surrounding the stator 16, and with the airgap G remaining radial. For illustrative consistency, the embodiment of FIG. 1 in which the rotor assembly 14 resides radially within the stator 16 will be described hereinafter without limiting the construction to such a configuration.

The electric propulsion system 10 includes an alternating current (“AC”) voltage bus 13. The AC voltage bus 13 may be selectively energized via a traction power inverter module (“TPIM”) 28 using a high-voltage battery pack (“B_{HV}”) 24, for instance a multi-cell lithium ion, lithium sulfur, nickel metal hydride, or other high-energy voltage supply. The AC voltage bus 13 conducts an AC voltage (“VAC”) to or from phase windings of the electric machine 12 to generate output torque (arrow T_{M}). The output torque (arrow T_{M}) from the energized electric machine 12, when operating in a drive or motoring mode, is then imparted to a connected rotor shaft 50 and directed to a coupled load (“L”) 52, such as by not necessarily limited to road wheels of a motor vehicle, a propeller shaft, or a drive belt.

The electric propulsion system 10 shown schematically in FIG. 1 may also include a DC voltage bus 15 to which is connected a direct current-to-direct current (“DC-DC”) converter 26. The DC-DC converter 26 is configured to reduce or increase a relatively high DC voltage (“VDC”) as needed via internal switching and filtering operations, as will be appreciated by those of ordinary skill in the art. The DC-DC converter 26 is connected between the battery pack 24 and the TPIM 28 via positive (+) and negative (−) rails of a high-voltage side of the DC voltage bus 15. In some configurations, a low-voltage/auxiliary battery pack (“B_{AUX}”) 124 may be connected to positive (+) and negative (−) rails of a low-voltage side of the DC voltage bus 15, with the auxiliary battery pack 124 possibly embodied as a lead-acid battery or a battery constructed of another application-suitable chemistry and configured to store or supply a 12-15V auxiliary voltage (“V_{AUX}”) to one or more connected auxiliary devices (not shown).

Referring to FIG. 2, the electric machine 12 includes the above-noted rotor assembly 14. Some embodiments of the rotor assembly 14 include a cylindrical rotor 40 having an embedded set of rotor magnets 55. The rotor magnets 55 may be embodied, for example, as permanent magnets constructed of ferrite, neodymium iron boron (“NdFeB”), samarium cobalt (“SmCo”), or another application-suitable magnet material. The rotor magnets 55 may be mounted to and/or embedded within individual steel lamination layers of the rotor 40. The construction of the rotor 40 may vary with the application, and therefore the depiction in FIG. 2 is exemplary of just one possible embodiment of the rotor 40.

The stator 16 is cylindrical in shape to circumscribe the likewise cylindrical rotor 40 of the rotor assembly 14 in the depicted exemplary embodiment, and is separated from the rotor 40 by the above-noted airgap G. In such a configuration, the stator 16 and rotor 40 may be constructed from a respective stack-up of thin lamination layers of electrical steel or another ferrous material, e.g., 2-5 mm thick, as will be appreciated by those of ordinary skill in the art.

The stator 16 also has radially-projecting stator teeth 32. Each stator tooth 32 extends radially inward from a cylindrical stator housing 30, with the stator housing having an outer diameter surface 160. The stator teeth 32 thus extend inward from the stator housing 30 toward an outer diameter surface 140 of the rotor 40. Adjacent stator teeth 32 of are separated from each other by a corresponding stator slot 33, i.e., each stator slot 33 is defined and flanked by an adjacent pair of the stator teeth 32. Stator windings 35 are then positioned within the stator slots 33.

In the depicted embodiments, the stator windings 35 are configured as bar segments constructed of copper or another electrically conductive material. Bar-type conductors, which are commonly referred to as “hairpin” conductors, are thus more substantial and rigid than the cylindrical copper wires typically wrapped or wound around the stator teeth 32. As noted above, a rotating stator magnetic field is generated when the stator windings 35 are sequentially energized by an AC output voltage, e.g., from the TPIM 28 depicted in FIG. 1. Stator magnetic poles formed from the resulting rotating stator field will interact with rotor poles provided by the various rotor magnets 55 of the rotor 40. Forces generated in the stator-rotor airgap G ultimately rotate the rotor shaft 50 and the coupled load 52 of FIG. 1.

As will be appreciated by those of ordinary skill in the art, stator teeth of a typical stator would extend radially inward toward a rotor, such that each stator tooth forms a cantilever with a distal end. Adjacent stator teeth are separated from each other a short distance by an opening or tooth gap, with the tooth gaps being contiguous with the stator-rotor air gap G. In other words, the stator slots of a typical rotary electric machine are open to the stator-rotor airgap G. In contrast, each of the stator teeth 32 of the present disclosure, as shown in FIG. 2, has an end 360 connected to the stator housing 30 and a distal end 33E located adjacent to the outer diameter surface 140 of the rotor 40. The distal ends 33E collectively define an inner diameter surface 260 of the stator 16, with two immediately adjacent distal ends 33E indicated by area 36 in FIG. 2. The stator slots 33 of adjacent stator teeth 32 are therefore fully closed in area 36 such that none of the stator slots 33 are contiguous with or open into the stator-rotor airgap G.

To construct a stator 16 having such a configuration, the stator teeth 32 are joined together or integrally formed during manufacturing of the stator 16. For instance, the thin lamination layers noted above may be individually punched with a tool (not shown) having the desired shape of the stator slots 33 of FIG. 2. The stator slots 33 will result when such lamination layers are stacked up and joined together. The resulting slots 33 between adjacent stator teeth 32, which are referred to hereinafter as in-slot coolant passages 33C, are then used as fluid conduit for circulating the coolant 21 of FIG. 1 axially through the stator 16. Cooling of the stator 16 by forced convection is thus enabled.

Referring briefly to FIGS. 3A and 3B, the stator windings 35 of FIG. 2 may be alternatively embodied as stator windings 135 (FIG. 3A) or 235 (FIG. 3B). Within the slots 33 of FIG. 2, copper losses may be higher nearest the inner diameter surface 260 of the stator 16. As a result, it would be advantageous to configure the stator windings 35, 135, or 235 to conduct more of the coolant 21 to areas located in proximity to the inner diameter surface 260. For example, rather than using the stator windings 35 of FIG. 2, which have a rectangular cross-section, one or more outer perimeter surfaces 135P of the stator winding 135 may be modified to direct more of the coolant 21 relative to other outer perimeter surfaces 135P, or relative to a square or rectangular cross-sectional shape.

For instance, one or more corners 37 of the stator windings 135 of FIG. 3A may be removed to conduct more of the coolant 21 to a particular area, and/or outer perimeter surfaces 235P of the stator windings 235 of FIG. 3B may be punched or otherwise shaped to form semi-circular troughs 39. Some such troughs 39 could be larger nearest the inner diameter surface 260 of the stator 16 of FIG. 2, such as the enlarged trough 39A of FIG. 3B. The size, shape, and/or placement of such troughs 39 or 39A may vary with the application to provide a desired flow rate and distribution of the coolant 21 within the in-slot coolant passages 33C of FIG. 2. Likewise, stator windings 35 may be envisioned with other non-rectangular profiles or features not described herein, e.g., star-shaped, triangular, or another polygon shape, and therefore the exemplary shapes of FIGS. 3A and 3B are illustrative of the present teachings without limitation.

Referring to FIG. 4, a representative cross-section of the electric machine 12 of FIG. 1 is depicted with respect to an axis of rotation AA of the rotor assembly 14. The electric machine 12 is shortened in the axial direction via jagged cutaway lines for illustrative simplicity, as will be appreciated, and therefore FIG. 4 is intended to be schematic and not necessarily proportional. That is, the rotor assembly 14 inclusive of the (“R”) rotor 40 and the rotor shaft 50, will rotate within the stator (“S”) 16 when the stator windings 35 are energized. The rotor shaft 50 may be splined or journaled to, or integrally formed with, the rotor 40 for common rotation of the rotor 40 and rotor shaft 55. The rotor magnets 55 are embedded within the rotor 40 in the illustrated embodiment. The stator 16 resides radially outside of the rotor 40, with the rotor 40 being rotatably supported at each end by a bearing assembly (not shown), as will be appreciated by those of ordinary skill in the art.

In order to convectively cool the stator 16 in accordance with the present disclosure, the coolant manifold 60A shown schematically in profile in FIG. 1 has ring-shaped/annular shape in plan view, and is mounted to a distal end surface 70 of the stator 16. The coolant manifold 60A, which in the illustrated “mounted” position circumscribes the axis of rotation AA, may be constructed of aluminum, plastic, or another non-magnetic material. The coolant manifold 60A in a possible construction includes opposing axial walls 74 joined by a radial wall 75, such that a manifold channel 76 is defined by the coolant manifold 60A and the end surface 70 of the stator 16.

For example, end surfaces 74E of the axial walls 74 abut and seal against the end surface 70 of the stator 16 to thereby encapsulate the stator windings 35 within the manifold channel 76 as shown. To ensure proper sealing, a biasing member 65, e.g., a bolt or a beam, may react against a stationary member 80 to apply a continuous compressive force (arrow FC) to the coolant manifold 60A. Additionally, the end surfaces 74E define holes or slots 79 that allow the stator windings 35 to pass through into the stator slots 33 (see FIG. 2). The coolant 21 of FIG. 1 is then directed downward into the coolant manifold 60A as indicated by arrow F, e.g., through a fluid inlet 78 defined by the uppermost axial wall 74, whereupon the admitted coolant 21 flows axially through the stator 16 via the in-slot coolant passages 33C shown in FIG. 2.

Also shown in FIG. 4 at an opposite end of the stator 16 is another coolant manifold 60B. The coolant manifold 60B is configured to allow the coolant flow (arrow F) to exit the stator 16 at a desired location or locations, e.g., via a fluid outlet 79. As will be appreciated, such an end may also include exposed phase leads (not shown) that extend through the fluid outlet 79 and are ultimately connected to the TPIM 28 of FIG. 1. The exposed phase windings and possibly other structure such as gear sets and bearings may make it relatively difficult to fully seal the coolant manifold 60B to the stator 16 if a perfectly annular embodiment of the coolant manifold 60B is employed. Thus, the annular construction of the coolant manifold 60B depicted for clarity and simplicity may be modified as needed to accommodate such intervening or surrounding structure, and thus a perfectly annular construction, i.e., in which the coolant manifold 60B has a circular perimeter in plan view, may be possible at just one end of the electric machine 12.

As noted above, coolant 21 in the form of ATF is often sprayed and/or spilled directly onto exposed phase leads of the stator 16. The coolant 21 thereafter settles via gravity and is recirculated to the sump 22 of FIG. 1. Therefore, it is not essential that the coolant manifold 60A be fully sealed around its perimeter assuming the pump 20 shown in FIG. 1 is configured to maintain the required flow rate of coolant 21 through the stator 16. Some spillage or overflow may occur, and in fact may be beneficial. The stator windings 35 may be skewed radially outward as shown, e.g., via a ramped surface 174 of one of the axial walls 74, so that the coolant manifold 60A is provided with a more substantial or stiffer construction. By substantially enclosing the stator slots 33 of the stator 16 in the manner described above, a uniform/360° flow is enabled around each of the stator windings 35, with the coolant 21 thereby directly removing heat from its source.

Proper spacing of the stator windings 35 within the manifold channel 76 of FIG. 4 will help ensure optimal distribution of the coolant 21 within the above-noted in-slot coolant passages 33C of FIG. 2. That is, if surrounding spaces between adjacent stator windings 35 within the slots 33 are too large, this may result in suboptimal cooling as the coolant 21 quickly settles toward radially inward regions of the in-slot coolant passages 33C proximate the rotor 40. If the space between adjacent stator windings 35 is too small, however, the flow of coolant 21 within the in-slot coolant passages 33C will tend to be uniform. At the same time, additional fluid pressure may be needed to circulate the coolant 21 through the in-slot coolant passages 33C.

Referring again to FIG. 2, for example, the slots 33 may have an elongated rectangular shape in cross-sectional view, i.e., extending radially between the inner diameter surface 260 of the stator 16 toward the outer diameter surface 160. Adjacent stator teeth 32 are fully closed at area 36, as noted above, such that the stator slots 33 are not contiguous with or open to the stator-rotor airgap G. Spacing in such an embodiment may be explained using an example in which the area of the slot 33 is about 50 mm². The cross-sectional area of the stator windings 35 within the slot 33, using six bars of copper as shown, is about 35 mm². As will be appreciated, the stator slot 33 would also include insulating material around its perimeter consuming another 8 mm². Thus, the 50 mm² of total slot area is reduced to about 7 mm² in this non-limiting example embodiment. Thus, the 7 mm² of available spacing may be distributed within the slot 33 such that more space is provided near the stator windings 35 proximate the outer diameter surface 160 of the stator 16.

As will be appreciated, the above disclosure lends itself to a method for cooling the stator 16. For instance, the method may include providing the stator 16 of FIG. 2, i.e., spaced apart from the rotor 40 by the stator-rotor airgap G and having stator teeth 32 collectively defining stator slots 33. Distal ends 33E of adjacent pairs of the stator teeth 32 are joined together or integrally formed such that the stator slots 33 are not contiguous with the airgaps G. Stator windings 35 constructed from hairpin or bar-type conductors and extending axially through the stator 16 within the stator slots 33.

The method may include sealing the coolant manifold 60A against an axial end surface 70 of the stator 16, as shown in FIG. 4, to thereby enclose therein a portion of the stator windings 35. The additional coolant manifold 60B may be sealed against the opposite distal end of the stator 16 as explained above, e.g., using another biasing member 65. Coolant 21 from the sump 22 of FIG. 1 or another coolant supply is directed into the enclosed stator slots 33C of FIG. 2 through the axial end surface 70 via the coolant manifold 60A to thereby cool the stator 16 via forced convection. Circulating coolant 21 into the enclosed stator slots 33C may include circulating the coolant 21 along the concave channel 39 or 39A of FIG. 3B in some embodiments.

Sealing the coolant manifold 60A against the axial end surface 70 of the stator 16 may include encapsulating a portion of the stator windings 35 within the manifold channel 76, which as shown in FIG. 4 is defined by opposing axial walls 74 joined by a radial wall 75 of the coolant manifold 60A. One of the axial walls 74 may include the ramped surface 174, and therefore sealing the coolant manifold 60A may include skewing the stator windings 35 in a radially outward direction via the ramped surface 174 and possibly using the biasing member 65 of FIG. 4 to apply the continuous compressive force (arrow FC) to the coolant manifold 60A.

Enclosing the stator slots 33 to form the in-slot cooling passages 33C as set forth above therefore provides a variety of benefits beyond efficient cooling of the stator 16. Some benefits are primarily mechanical or structural in nature. For instance, a stator tooth of a typical electric machine forms a cantilever. Since cantilevers by definition are supported at just one end, the free end of such a stator tooth is prone to vibration and noise. Enclosing the stator slots 33 in accordance with the present disclosure eliminates such cantilevers and thereby adds structural rigidity to the stator 16. Slot noise due to torque ripple and the resulting undesirable NVH effects are reduced. Likewise, the disclosed construction of the stator 16 reduces torque ripple due to the minimization of the slotting effect within the stator-rotor airgap G, including possible reduction of windage or drag losses in the stator-rotor airgap G. These and other possible benefits will be readily appreciated by those of ordinary skill in the art in view of the forgoing disclosure.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A rotary electric machine for use with a coolant supply, comprising:
a rotor assembly having a rotor and a rotor shaft connected together and configured to rotate about an axis of rotation;
a stator spaced apart from the rotor by a stator-rotor airgap and having stator teeth collectively defining enclosed stator slots, wherein distal ends of adjacent pairs of the stator teeth are joined together or integrally formed such that the enclosed stator slots are not contiguous with the airgap;
stator windings constructed from hairpin or bar-type conductors and extending axially through the stator within the stator slots; and
a coolant manifold in fluid communication with the coolant supply, constructed of non-magnetic material, and configured to seal against an axial end surface of the stator to thereby enclose therein a portion of the stator windings, wherein the coolant manifold is configured to receive coolant from the coolant supply, direct the received coolant into the enclosed stator slots through the axial end surface of the stator, and thereby cool the stator via forced convection.

2. The rotary electric machine of claim 1, further comprising an additional coolant manifold in fluid communication with the coolant supply, constructed of the non-magnetic material, and configured to seal against another axial end surface, wherein the additional coolant manifold is configured to receive coolant from the enclosed stator slots.

3. The rotary electric machine of claim 1, wherein an outer perimeter surface of at least one of the stator windings defines a concave channel configured to conduct the coolant along the outer perimeter surface.

5. The electric machine of claim 1, wherein the coolant manifold includes opposing axial walls joined by a radial wall such that a manifold channel is defined by the coolant manifold and the axial end surface of the stator, and wherein the axial walls abut and seal against the end surface of the stator to thereby encapsulate the stator windings within the manifold channel.

6. The electric machine of claim 5, wherein one of the axial walls includes a ramped surface and the stator windings are skewed in a radially outward direction via the ramped surface.

7. The electric machine of claim 6, further comprising a biasing member configured to apply a continuous compressive force to the coolant manifold.

8. The electric machine of claim 7, wherein the biasing member is a bolt or a beam configured to react against a stationary member to thereby apply the continuous compressive force.

9. The electric machine of claim 1, wherein available spacing between the stator windings within each of the enclosed stator slots is unevenly distributed, such that more of the coolant is directed to the stator windings located in proximity to an outer diameter surface of the stator than to the stator windings located in proximity to an inner diameter surface of the stator.

10. The rotary electric machine of claim 1, wherein the rotor shaft is connected to a driven load aboard a motor vehicle having a coolant pump, and the coolant is circulated via the coolant pump.

11. An electric propulsion system comprising:
a high-voltage battery pack;
a direct current-to-direct current (“DC-DC”) converter connected to the high-voltage battery pack;
a traction power inverter module (“TPIM”) connected to the high-voltage battery pack and configured to output an alternating current (“AC”) voltage;
a polyphase rotary electric machine connected to the TPIM and energized via the AC voltage, the rotary electric machine including:
a rotor assembly having a rotor and a rotor shaft connected together and configured to rotate about an axis of rotation;
a stator spaced apart from the rotor by a stator-rotor airgap and having stator teeth collectively defining enclosed stator slots, wherein distal ends of adjacent pairs of the stator teeth are joined together or integrally formed such that the enclosed stator slots are not contiguous with the airgap;
stator windings constructed from hairpin or bar-type conductors and extending axially through the stator within the enclosed stator slots;
an annular coolant manifold in fluid communication with a coolant supply, constructed of non-magnetic material, and configured to seal against an axial end surface of the stator to thereby enclose therein a portion of the stator windings, wherein the coolant manifold is configured to receive coolant from the coolant supply, direct the received coolant into the enclosed stator slots through the axial end surface of the stator, and thereby cool the stator via forced convection;
an additional coolant manifold in fluid communication with the coolant supply, constructed of the non-magnetic material, and configured to seal against another axial end surface, wherein the additional coolant manifold is configured to receive coolant from the enclosed stator slots; and
a driven load connected to the rotor shaft and powered via torque from the electric machine.

12. The electric propulsion system of claim 11, wherein the driven load is a set of road wheels of a motor vehicle having a coolant pump, and the coolant is circulated via the coolant pump.

13. The electric propulsion system of claim 11, wherein an outer perimeter surface of at least one of the stator windings defines a concave channel configured to conduct the coolant along the outer perimeter surface.

14. The electric propulsion system of claim 11, wherein the annular coolant manifold includes opposing axial walls joined by a radial wall such that a manifold channel is defined by the coolant manifold and the axial end surface of the stator, and wherein the axial walls abut and seal against the end surface of the stator to thereby encapsulate the stator windings within the manifold channel.

15. The electric propulsion system of claim 14, wherein one of the axial walls includes a ramped surface and the stator windings are skewed in a radially outward direction via the ramped surface, the electric propulsion system further comprising a biasing member configured to apply a continuous compressive force to the coolant manifold.

16. The electric propulsion system of claim 11, wherein available spacing between the stator windings within each of the enclosed stator slots is unevenly distributed, such that more of the coolant is directed to the stator windings located in proximity to an outer diameter surface of the stator than to the stator windings located in proximity to an inner diameter surface of the stator.

17. A method for cooling a stator of a rotary electric machine, the method comprising:
providing a stator spaced apart from the rotor by a stator-rotor airgap and having stator teeth collectively defining enclosed stator slots, wherein distal ends of adjacent pairs of the stator teeth are joined together or integrally formed such that the enclosed stator slots are not contiguous with the airgaps, and wherein stator windings constructed from hairpin or bar-type conductors and extending axially through the stator within the enclosed stator slots;
sealing an annular coolant manifold against an axial end surface of the stator to thereby enclose therein a portion of the stator windings;
circulating coolant from a coolant supply into the enclosed stator slots through the axial end surface of the stator via the annular coolant manifold to thereby cool the stator via forced convection.

18. The method of claim 17, wherein circulating coolant from the coolant supply into the enclosed stator slots includes circulating the coolant along a concave channel defined by an outer perimeter surface of at least one of the stator windings.

19. The method of claim 17, wherein sealing the annular coolant manifold against the axial end surface of the stator includes encapsulating a portion of the stator windings within a manifold channel defined by opposing axial walls joined by a radial wall of the coolant manifold.

20. The method of claim 19, wherein one of the axial walls includes a ramped surface and sealing the annular coolant manifold includes skewing the stator windings in a radially outward direction via the ramped surface and using a biasing member to apply a continuous compressive force to the coolant manifold.
